(19) United States
(12) Patent Application Publication
(10) Pub. No.: US 2016/0356143 A1
(43) Pub. Date: Dec. 8, 2016

(54) DEEPWATER PRODUCTION SYSTEM

(71) Applicant: Kvaerner AS, Lysaker (NO)

(72) Inventor: Rolf Eie, Oslo (NO)

(73) Assignee: Kvaerner AS, Lysaker (NO)

(21) Appl. No.: 14/902,493

(22) PCT Filed: Jul. 8, 2014
(86) PCT No.: PCT/EP14/64617

§ 371 Date: Dec. 31, 2015

(30) Foreign Application Priority Data
Jul. 10, 2013 (NO) 20130964

(51) Int. Cl. E21B 43/36; C02F 1/00; B01D 17/02; E21B 43/40; B01D 19/00

(52) U.S. Cl. CPC E21B 43/36; E21B 43/40; B01D 19/0068; B01D 17/0208; C02F 1/00; C02F 2001/007; C02F 2103/10

(57) ABSTRACT

A method and system for oil production in remote deep-water areas, especially in areas where weather or ice conditions may require closing and removal of surface facilities and equipment. Processing of the produced oil from subsea oil wells is partly performed subsea on a subsea oil and gas production unit (10) called Deepwater Production System (DPS), whereas the remaining processing takes part on a vessel (1) that may be disconnected from the DPS if the conditions make it necessary. The method and system take advantage of combining and integrating subsea processing with processing at atmospheric pressure onboard the vessel.

### TECHNICAL FIELD

The present invention relates to a deep-water production system for oil in areas where the conditions may require closing and removal of surface facilities and equipment. Conditions requiring closing down and removal of equipment at the surface may be approaching severe ice conditions or extreme weather conditions or a combination thereof.

### BACKGROUND

Large oil resources are found in remote areas offshore, where rough weather conditions, and even ice, may be expected. To avoid or reduce the impact of ice and/or extreme weather conditions, or to enable production on marginal oil and gas field, subsea installations are used for production and storage of the product.

Even the strongest man-made structures may be damaged or totally destroyed by the enormous forces of a drifting iceberg or ice islands in heavy weather conditions. Production units arranged at the seabed makes it possible to avoid challenges from heavy weather and ice. Such production units are well known, see e.g. U.S. Pat. No. 6,817,809. The subsea production units are often arranged as satellite plants connected to a “mother plant”, such as a platform, by pipeline(s) and/or power and control line(s), for efficient production at marginal oil and gas field, or in deep waters.

The fluid taken up from a subterrain oil well is a mixture of hydrocarbons in the form of natural gas, such as methane, ethane, propane and butane, and oil, CO₂ gas and water. The exact composition thereof varies from oil field to oil field and through the lifetime of an oil well. Oil and water are separated by means of gravitational separation in one or more tanks(s) arranged at the sea bed. Oil and gas may be separated in a subsea process system. Produced oil may be transferred to ships for transport to market. Natural gas may be transferred to ships or transported though pipelines to the marked, or may be re-injected into the reservoir as a pressure support together with CO₂ present in the gas. The separated water may be re-injected into the reservoir as pressure support, and/or may be released into the surrounding sea.

WO2012102806 relates to a subsea production system having an arctic production tower, wherein the production tower is a subsurface construction having a landing deck for receiving and landing a floating drilling unit and wherein the drilling unit may be disconnected and moved to a safe location in heavy weather conditions or if an ice berg approaches the production system. The drilling unit and the subsea unit may again be reconnected and production continued as soon as the conditions allows.

US20120047942 relates to offshore for processing of crude oil, LNG and LPG, using floating facilities such as production vessels for separating and further treating raw oil/gas from subsea wells for export for the facility in form of any of the mentioned products. It is mentioned that associated gas may be exported from the field or re-injected, but there is no specific description on reinjection.

CA 2751810 relates to a system and a method for hydrocarbon production offshore in harsh environments. The system comprises a subsea storage facility for receiving hydrocarbons from a subsea production. The system also comprises a process plant for processing produced oil for stabilization thereof, and injectors for reinjection of separated produced water and separated gas. The plant receives power from a vessel connected to the system via an umbilical and a turret that may be loosened fast if the conditions so requires.

The system may be operated when disconnected from the vessel by means of power from a subsea power plant.

U.S. Pat. No. 6,893,486 relates to a method and system for sea-based handling of hydrocarbons. The system comprises a subsea high-pressure separator for a first step separation of water and associated gas from the produced oil. The water and gas separated at this separation step, are re-injected by means of multiphase pumps, whereas the partly stabilized oil is pumped onboard a vessel via an umbilical. Onboard the vessel the oil is further stabilized, and the separated residual gas is used as fuel for power generation.

WO2010144187 relates to a subsea hydrocarbon recovery system and methods, the system comprising gravity separation tanks and a subsea production system for separation of gas, water and oil, and injectors for injection of produced water and/or gas into the reservoir or other sub-terrain structure. An offload system may also be provided.

Oil and gas separation, or stabilization, is performed i.a. to allow transport of the produced oil at about atmospheric pressure. Even if most methane is spontaneously separated from oil at high pressures, oil/gas separation is most efficiently performed at a low pressure, such as atmospheric pressure, to ensure an efficient separation even of higher molecular weight gas fractions, such as ethane, propane, butane and pentane. Separation at lower pressures is normally less power efficient and/or does not give sufficient stabilization of the oil for transport.

Working in harsh environments, such as in areas where icebergs may occur, requires solutions that allows for disconnection of surface vessels, either a floating production unit or transport vessels loading oil in case of heavy weather condition and/or approaching icebergs, and requires specially adopted solutions not solved by any of the prior art solutions mentioned above.

An object for the present invention is to provide an improved method and an improved system allowing substantially continuous, or at least semi-continuous remote deep-water oil production in waters where weather and/or ice conditions makes in necessary to disconnect production units at the surface from seabed based units for a shorter or longer period. Other objects of the invention will become clear for the skilled person in reading the present description and claims.

### SUMMARY OF THE INVENTION

According to a first aspect, the present invention relates to a method for oil production in remote deepwater areas, the method comprising the steps of:
producing hydrocarbons from one or more subsea well(s) and introducing the produced hydrocarbons into one or more separation and storage tank(s) in a subsea oil production unit (DPS) resting at the sea bed,
allowing the produced hydrocarbons to separate from associated gas and water in one or more tanks, to give a gas phase, an oil phase and a produced water phase,
conducting at least a part of the produced water separated from the oil in the DPS to subsea injection wells through an injection pump,
providing a temporary fluid connection between the separation and storage tank(s) and a production and transport vessel for transporting separated oil from the tank(s) to the vessel and gas and water from the vessel,
conducting separated oil from the separation and storage tank(s) to the vessel,
separating the stream of hydrocarbons into stabilized oil, gas and water in a separation system onboard the vessel,
introducing the stabilized oil into storage tank(s) onboard the vessel,
returning separated gas and water to the DPS,
injecting the returned water and/or gas into water and/or gas injection wells, respectively,
disconnecting the vessel from the fluid contact if disconnection is required,
continuing hydrocarbon production from the subsea well(s) when the DPS and the vessel are disconnected until the separation and storage tank(s) are filled.

The present method allows for substantially continuous oil production, at least for a certain period of disconnection between the subsea production unit (DPS) and the production vessel, so that the production may continue for a period even if weather or ice conditions does not allow for the vessel to be connected to the DPS, or if the vessel has to leave the position for transport of oil from the field.

Additionally, by performing a first separation of the produced stream from the oil well subsea, and thereafter further separate the oil phase from associated gas and water onboard the vessel, the volumes to be transported through risers up from the subsea unit to the vessel and down again is substantially reduced compared to performing all of the separation onboard the vessel. This allows for reducing the piping capacity and thus the cost thereof, and reduction of the onboard separation equipment. Performing the last separation step, the so called stabilization of the oil, i.e. removal gas from the oil is far more efficient at or close to atmospheric pressure than at higher pressures, onboard the vessel, also allows for an efficient and cost efficient stabilizationstep of the total process.

According to one embodiment, gas separated from the oil inside the separation and storage tanks(s) is withdrawn from the tank(s) and injected into the gas injection well(s). At least a part of the gas will spontaneously separate from the oil in the separation and storage tank and form a gas phase at the top of the oil. The amount of gas spontaneously separated at the sea bed separation and storage tank depends on the ambient pressure, temperature, amount of volatile compounds in the produced hydrocarbons, and the composition of the volatile components. Most methane will spontaneously separate in the seabed tank and is withdrawn therefrom to be injected.

According to one embodiment, the gas and/or water injection is continued even when the vessel is disconnected. Continuous injection of gas and/or water allows efficient oil recovery by keeping the pressure in the oil field at an optimal level for efficient production, and to be able to optimize the production as soon as a vessel is connected to the plant.

According to another embodiment, the displacement water pool additionally comprises gravitation purification of displacement water prior to discharge into the sea or prior water injection of surplus displacement water into the sea.

According to one embodiment, water separated from the produced oil onboard the vessel and returned the DPS is treated by gravitational cleaning in a water separation tank before discharge to sea. Cleaning of the water by gravitational separation has been proven to be very efficient for water/oil mixtures. Dedicated water separation tank(s) helps to increase the water residence time before discharge to sea and thus to reduce the concentration of oil in the water to be released.

According to one embodiment, the produced water returned to the DPS after being separated from the oil in the separator system onboard the vessel, is injected directly into the reservoir. This is done to avoid mixing this water with seawater as mixing of seawater and produced water may result in scaling in the injection well and piping system.

According to a specific embodiment, the vessel is a production vessel and the method further comprises transferring the oil from the storage tank(s) to tank vessels for export of the oil. By using a specialized production vessel, any convenient tank vessel certified for the waters in question may be used for transport of the oil away from the oil field. The transfer of oil from the production vessel to a transport vessel may be performed by means of solutions that are well known for the skilled person and that is in use all over the world for such transfer of fluids.

According to another specific embodiment, the vessel is a combined production and transport vessel and where the vessel is disconnected for exporting the oil when the storage tank is filled. By using combined production and transport vessels, the local investments in setting up the production facility is substantially reduced over using specialized production vessels, on the cost of a production unit onboard each transport vessel. However, this solution does improve the flexibility in capacity for production from offshore fields of different sizes.

According to a second aspect, the present invention provides a system for oil production in remote deep-water areas, the system comprising a DPS, comprising one or more tanks for oil and gas arranged on the sea bed, one or more hydrocarbon production well(s) connected to the DPS via raw oil line(s), one or more injection well(s) for gas and/or water connected via water and/or gas pipelines, a power, monitoring and control cable connected to the DPS and a remote location, flexible flow risers for gas, oil and water, respectively, connected to the DPS , designed to be removably connectable to combined production and transport vessel(s),

wherein the system additional comprises a production vessels equipped with a separator system for separation of the produced oil into separated oil to be filled in tanks onboard the vessel, gas, and water, and where a water riser and/or a gas riser are provided for returning water and gas, respectively to the sea bed for injection for pressure support for enhanced oil recovery.

According to one embodiment, the water riser is connected to a water injection line on the DPS to allow for direct injection of the return water.

According to another embodiment, the system additionally comprises anchor lines connected to anchors in one end, and removably connectable to the production vessel.

According to one embodiment, the flow risers are removably connectable to the vessel by means of a submerged turret production buoy that can be connected to the vessels being provided with a turret.

According to one specific embodiment, the production vessel is a combined production and transport vessel.

According to a second specific embodiment, the system further comprises an offloading arrangement for offloading of oil to tank vessels for export of the oil.

Common for all embodiments is that the present invention makes it possible to produce oil from small remote offshore oil and gas fields, in waters where icy conditions and/or extreme weather conditions may be expected.

### BRIEF DESCRIPTION OF THE DRAWINGS

FIG. 1 is a flow diagram of first embodiment according to the invention,

FIG. 2 is a flow diagram of a second embodiment of the present invention, and

FIG. 3 is a flow diagram of a third embodiment of the present invention.

### DETAILED DESCRIPTION OF THE INVENTION

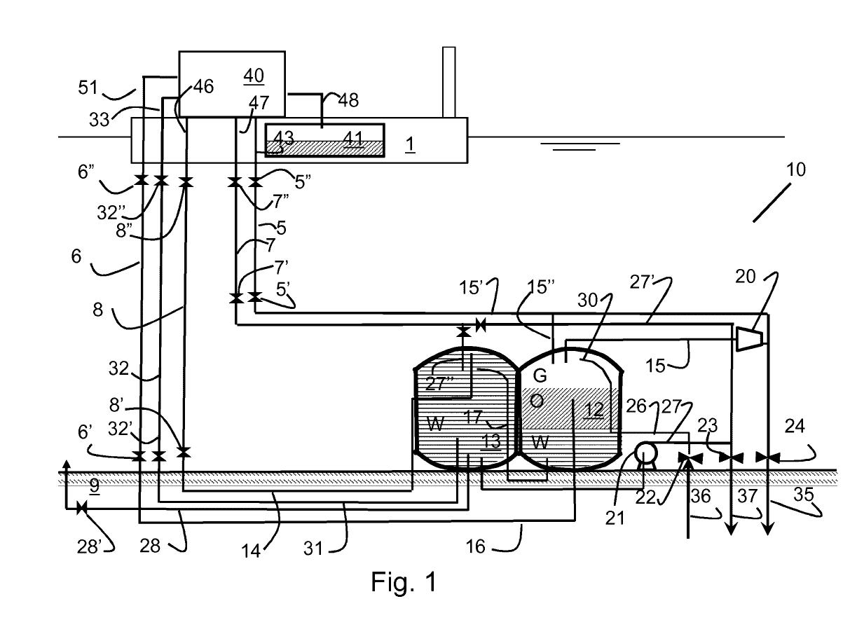

FIG. 1 is a flow diagram illustration of an embodiment the present invention. A Deepwater Production System (DPS) 10 comprising one or more separation tanks 12 for separation of oil, gas and water, pumps, compressors and equipment for controlling and monitoring the DPS and the parts thereof, is arranged at the sea bed 9. The separation tank(s) 12 is (are) are always filled with oil (O), gas (G) and/or water (W) as the tanks are in liquid connection with the surrounding water. Water, oil and gas spontaneously form three clearly separated phases in tank 12, the water being layered at the bottom of the tank, the gas at the top and the oil in between the water and gas. Due to the high pressure some gas will normally be dissolved in the oil phase, whereas some oil may be present in water phase due to incomplete separation. The water in the separation tank(s) 12 is substituted with oil and/or gas as fluid hydrocarbons are filled into the tanks, and water substitutes fluid hydrocarbons when hydrocarbons are removed from the separation tank(s) 12.

A water purification tank 13 is also preferably provided as a buffer and purification tank to purify any water that is released from the DPS to the surroundings, or that is to be re-injected as will be described in further detail below. Due to the fact that mixing of sea water and produced water, i.e. water withdrawn from the oil field together with the oil and gas, normally results in scaling as insoluble salts are formed, introduction of sea water into the water purification tank 13 is avoided, if possible. The produced water separated from the produced stream of oil in separation tank and further purified in the purification tank 13 may be released into the surrounding sea if the volume of produced water is larger than the volume that may be injected. Such surplus produced water may be withdrawn through a water line 28. A valve 28′ may be arranged in line 28 to control the flow of water in line 28, and to avoid ingress of seawater into the water purification tank 13.

A water communication line 17 is arranged between tanks 12 and 13 for withdrawing water from separation tank 12 and introduce the water into the water purification tank 13, close to the top of the water purification tank to allow time for separation of the water and any oil therein.

The subsea oil separation tank(s)12 is (are) receiving produced hydrocarbons from one or more subsea well(s) 36 via oil control valve 22 and a produced oil line 26 when hydrocarbons are produced from the well. The produced hydrocarbon stream in line 26 is filled into the tank(s) 12 close to the top thereof through a produced hydrocarbon inlet 30 to avoid unwanted introduction of hydrocarbons into the underlying water. The produced stream comprises a mixture of oil, natural gas, gaseous CO₂, and water. In the separation tank(s) 12 the produced stream spontaneously separates by gravitational separation into a water phase, an oil phase, in addition to a gas phase, including any lighter hydrocarbons, i.e. hydrocarbons that is normally in gas phase at the pressure and temperature at the seabed, in addition to CO₂.

The separated water, also named produced water, will sink in the less dense oil layer until it meets the water already present in the tank and combine with his water. In the figures the water phases are identified with W, the oil phase with G and the oil phase with O.

The water purification tank 13 is provided for separation and thus removal of any oil still present in the water before releasing the water into the surrounding sea or reinjection into reservoir by increasing the time for oil/water separation. Additionally, the water purification tank may act as an extra security measure in case of overfilling of the oil separation and storage tank 12 resulting in the introduction of oil or oil rich water into the water purification tank 13.

Depending on the residence time for the oil in the tanks 12, a part of the water in the oil, and most of the lighter gas therein, may separate from the oil. The water separated in the tanks 12 will mix with the water cushion already present in the tanks, whereas any gas will form a gas pocket at the top of the tank. Due to the high pressure in the separation and storage tank(s) 12 the oil/gas separation is far from efficient and the amount of gas separated in the tank(s) is normally limited to the lighter fractions such as methane.

Gas separated from the liquid hydrocarbon phase in the hydrocarbon tank can be withdrawn from the separation tank 12 through a gas pipe 15, compressed by a compressor 20 and injected into the reservoir through a gas injector well 35, controlled by a valve 24.

Oil is withdrawn from the separation tank(s) via an oil withdrawal line 16 and led to a production vessel 1 via an oil riser 6. Valves 6′ and 6″ are arranged at the top of the oil riser and at the seabed, respectively, to open and stop the flow in riser 6. The production vessel 1 may be a production and storage vessel, or according to one specific embodiment, it is a combined production and transport vessel.

Onboard the vessel 1, the oil is introduced via an oil line 51, into an onboard separator 40, in which the pressure of the oil is reduced to atmospheric or near atmospheric pressure, to obtain a further separation between liquid and gas.

The gas separated in the separator 40 is compressed, withdrawn through a gas line 43 and returned to the seabed via a gas return riser 5. Valves 5′, 5″ are provided at the top of the gas return riser and at the seabed, respectively, to open and stop the flow in the gas return riser 5.

At the seabed, the returned gas is led in a return gas line 15′, is combined with any gas from the separation tank 12, and is injected into the gas injection well 35 as described above. A part or all of the gas in line 15′ may, alternatively, be introduced into the separation tank(s) 12 and withdrawn from there via line 15 for injection.

Stabilized oil, i.e. oil that may be transported in a tanker at atmospheric pressure without releasing more gas, or only minor amounts of gas, is withdrawn through an oil withdrawal line 48, and introduced onto an oil tank 41.

The oil in tank 41 may be transferred to a shuttle tanker, or the vessel 1 may disconnect from the risers and the DPS and transport the oil ashore. If the vessel 1 is a combined production and transport vessel, another vessel is normally connecting to the risers and the DPS as soon as a first vessel is disconnecting for transport of the oil load.

Water separated in the separation system 40, is withdrawn through a return water line 47 and is returned to the DPS though a water return riser 7. The skilled person will understand that a pump is provided for pumping the water return to the seabed. Valves 7′, 7″ are provided at the top of the water return riser and at the seabed, respectively, to open and stop the flow in the water return riser 7. The water returned to the DPS via the water return riser 7 is preferably led in a water return water line 27′ to a water injector well 37 controlled by a valve 23, for injection into the reservoir. Alternatively, the water return may be introduced into the water purification tank 13 through a water line 27″, provided that no sea water has been introduced into the tank 13.

Water is withdrawn from the water purification tank 13 via an injection water line 27 and an injection pump 21, to be injected by means of a water injector well 37 together with any water in line 27′ returning from the vessel 1.

Minor amounts of oil and gas is separated in the water purification tank(s) 13, and are continuously or intermittently withdrawn through a gas and oil withdrawal line 14 and transferred via an oil and gas riser 8 to the vessel 1 and introduced for separation in the separator 40 via an onboard oil and gas line 46.

Valves 8′, 8″ are provided at the top of the water return riser and at the seabed, respectively, to open and stop the flow in the water oil and gas riser 8.

Optionally, minor amounts of the water in the separation tank 13 may be withdrawn through a water-sampling line 31 via a water-sampling riser 32 to the vessel for testing of the composition of the water in the separation tank 13. Valves 32′, 32″ are provided at the top of the water return riser and at the seabed, respectively, to open and stop the flow in the water-sampling riser 7. After taking water samples for testing from the water quality and composition to ascertain that the water has a quality and composition that are within the specifications allowed for either releasing water into the surrounding sea, or for injection, the water in the onboard water sampling line 46 is introduced into the separator 40.

The separator 40 is a fluid separation facility operating at, or close to, atmospheric pressure. All the incoming fluid streams introduced into the separator 40, i.e. the oil stream in line 51, the oil and gas introduced through line 46, and water for water sampling in line 33, are treated for separation of a gas phase comprising lower hydrocarbons and CO2, a water phase and an oil phase. As mentioned above, the gas phase and water phase are returned to the DPS for injection into injection wells 35, 37, whereas the oil is filled into tank 41 for export from the field.

The risers 5, 6, 7, 8, 32 are tubular members that may be arranged individually, or two or more arranged in a common umbilical, leading from the seabed to a connector to be connected to the vessel 1. Preferably, the connector for connecting the risers to the vessel 1 is a turret or a well-known type, allowing quick connection and disconnection of the vessel, both in normal operation and if the conditions makes a rapid disconnection necessary. A turret is a buoy adopted to fit into a connector in the vessel and allows for both anchorage for the vessel and for connecting the vessel to the risers. The valves 5′, 6′, 7′, 8′, 32′ are all arranged at the seabed, whereas the valves 5″. 6″, 7″, 8″, 32″ are all arranged at the turret buoy, to close the risers at both ends to stop the fluid flow and to avoid, or to stop, any leakage therefrom.

To avoid mixing of sea water and produced water, the separation tank 12 is preferably operated in a steady state mode. In the steady state mode, the liquid levels in the separation tank 12 is controlled to be substantially constant. Accordingly, the withdrawal of gas for injection through line 15, the withdrawal of produced water for injection directly from tank 12, or via the water purification tank 13, and the volume of oil in the separation tank 12, are controlled to maintain the substantially constant liquid level. Preferably, the volume per time unit for withdrawal of produced water for injection is lower than the volume per time unit for addition of water in the incoming produced stream, to keep the water level substantially constant by releasing produced water through line 28 to avoid ingress of sea water into the separation tank(s) 12 and/or purification tank(s) 13.

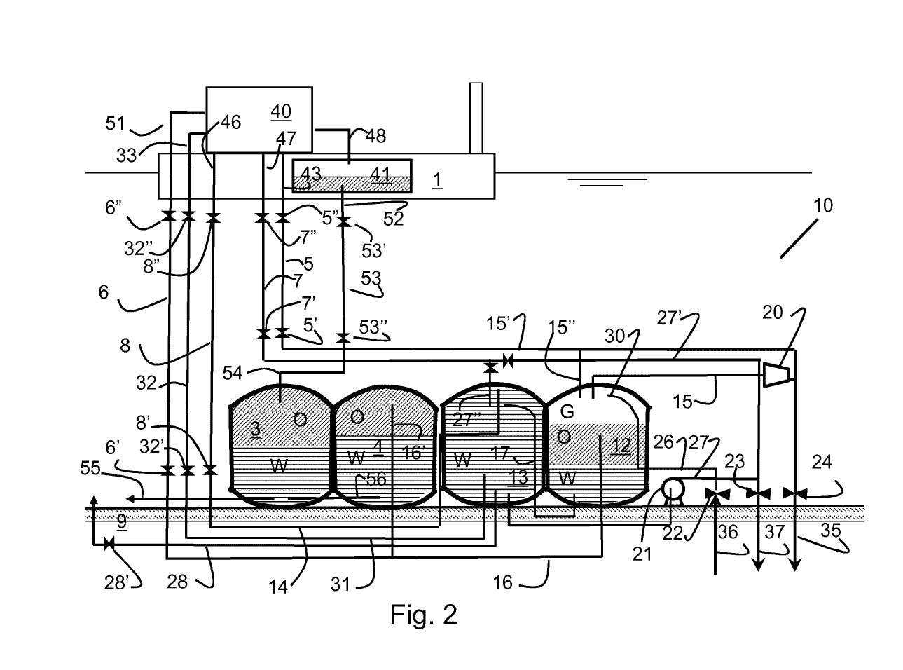

FIG. 2 illustrates another embodiment of the present invention, introducing one or more additional, and optional, tank(s) for storage of produced and not stabilized oil, and/or for stabilize oil. FIG. 2 illustrates an embodiment having two oil storage tanks 3, 4. Oil storage tank 3 is a tank for storage of stabilized oil, communication with the oil tank 41 onboard the vessel via an onboard stabilized oil line 52, a stabilized oil riser 53 and a subsea stabilized oil line 54. Valves 53′, 53″ are provided at the top of the stabilized oil riser and at the seabed, respectively, to open and stop the flow in the stabilized oil riser 7. The oil tank 3 is connected to the surrounding sea through a sea water line 55. The stabilized oil riser is adopted to transport stabilized oil from the vessel 1 to the stabilized oil tank 3, and in the opposite direction depending on the situation. During a stabile production period, tank 3 may be filled with stabilized oil for later export to the destination. As the stabilized oil is separated from the produced water, sea water may be used in the volume of the tank not filled by oil without causing scaling.

The other optional tank(s) illustrated in FIG. 2 is a produced oil tank(s) 4, which is connected to the oil phase of separation tank 12. Elements not specifically mentioned in the description of FIG. 2 corresponds to the same elements having the same reference numerals in FIG. 1. In FIG. 2 a produced oil storage line 16′ is connected to oil line 16 so that oil from the separation tank may be filled into the produced oil tank 4 as a buffer tank, e.g. during periods where the vessel 1 is not connected to the DPS via the risers. The oil phase in tank 4 floats on a pillow of water, preferably seawater, via a water communication line 56 illustrated to be connected to the water phase in tank 3. If no tank 3 is present, the water communication line 56 is in communication with the surrounding sea. The skilled person will understand that the water in tank(s) 3 and/or 4 may be used for injection if it the amount of produced water is too low compared with the demand for injection water. The water from tanks 3, 4 has to be injected into other not illustrated injection well(s) for sea water to avoid scaling due to mixing seawater and produced water.

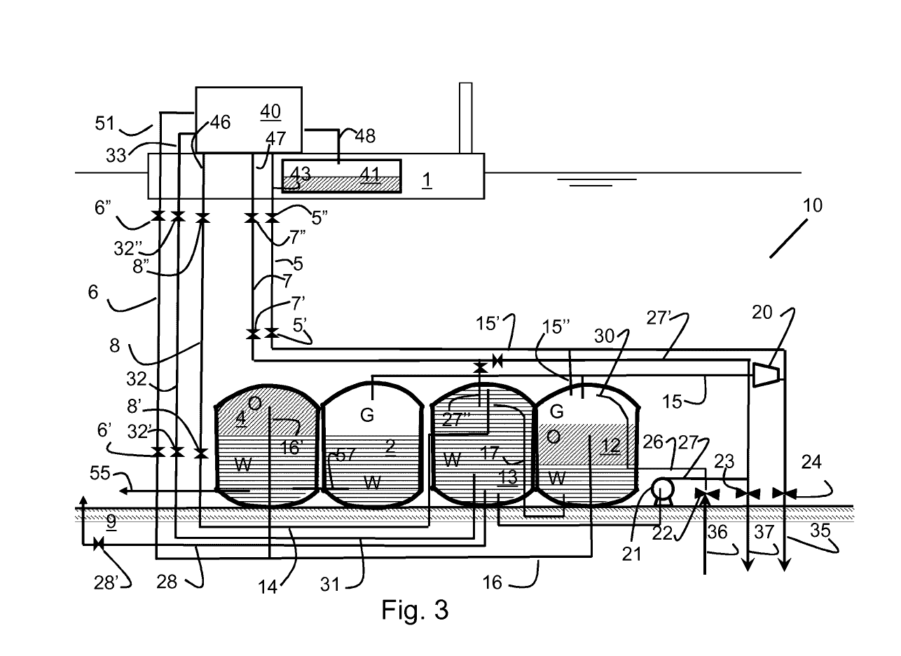

FIG. 3 illustrates a different embodiment, including two optional tanks, one produced oil storage tank 4, as described with reference to FIG. 2, and a gas storage tank 2, being a buffer tank for gas if required. The gas storage tank 2 is connected to the gas return line 15, and may receive gas from the separation tank 12 through line 15. The gas storage tank 2 communicates with the water of the surrounding sea and/or the tank 4, via a water communication line 57.

The skilled person will understand that the embodiments of FIGS. 1, 2 and 3 may be combined and that optional tanks may be replaced by other tanks. Additionally, the skilled person will understand that the volume and number of the respective tanks may differ from tank type to tank type. The skilled person will also understand that tanks illustrated by one tank in the drawings may represent one or more tanks. The subsea tanks are also illustrated as tanks having the same size, but this is for illustrative purpose only. As an example, in a typical plant including storage tanks for the produced oil withdrawn from the separation tank and/or stabilized oil, having a separation tank capacity of about 25000 m³, may have an oil storage capacity of typically about 200000 m³.

The DPS is intermittently connected to a combined production, storage and transport vessel 1 via flexible flow line risers 5, 6, 7, 8, 32 for transport of fluids from the DPS to the vessel 1, or from the vessel to the DPS. The flexible flow line risers 5, 6, 7, 8, 32 and the vessel 1 are designed to be rapidly connected or disconnected. When connected to the flow line risers 5, 6, 7, 8, 32, 53 the vessel is preferably connected to anchor lines for positioning of the vessel.

A suitable device for rapid and easy connection and disconnection of the flexible flow risers and anchor lines to/from the vessel 1 is a submerged turret production buoy designed to be connected to the vessel via a not shown turret arranged through the bottom of the vessel 1. The skilled man will understand that a turret production buoy connected to the flow risers and anchor lines is an example on a presently preferred solution for easy, rapid and secure connection and disconnection between the vessel 1 and the flow risers 5, 6, 7, 8, 32, 53 and not shown anchor lines, and that other solutions are possible. Turrets for this purpose is well known and has been at the marked for decades.

The flow risers are for transport of oil, gas, and water, respectively, and for taking out water for testing from the water purification tank 13. The risers are respectively gas riser 5, oil riser 6, water riser 7, gas offtake riser 8, displacement water sample riser 32, and the stabilized oil riser 53. The skilled person will understand that any of the illustrated risers may represent more than one riser if needed to give sufficient capacity.

All the flow risers are connected to the DPS. The skilled person will understand that two or more of the flexible risers 5, 6, 7, 8, 32, 53 may be combined in a common umbilical and/or be combined with power lines, control lines and/or pipes for hydraulics. Submerged turret buoys and connection of such buoys to turrets on vessels or floating production platforms, for loading/offloading of vessels, and/or for processing produced oil and gas on floating production platforms, are well known by the skilled person.

The water purification tank 13 is provided for separation and thus removal of any oil still present in the water before releasing the water into the surrounding sea by increasing the time for oil/water separation. Additionally, the water purification tank may act as an extra security measure in case of overfilling of the oil separation and storage tank 12 resulting in the introduction of oil or oil rich water into the water purification tank 13.

As the tanks 2, 3, are in fluid connection with the surrounding water, the pressure inside the tanks 2, 3, 4, 12, 13 is the ambient pressure at the relevant sea depth. The oil and/or gas in the tank(s) 12 rest on cushions of water that is in communication with the surrounding water as mentioned above, preferably via the water purification tank 13. Accordingly, water may enter the tanks or be discharged depending on the mode of operation for the system as will be described further below. Tanks for produced oil of the kind described are widely used for offshore oil production and displacement water discharged from such tanks generally shows an oil in water content of 5 ppm or lower, whereas the limit set for discharge of water in most areas is 40 ppm.

The DPS may receive electrical power and may be fully or partly controlled from the vessel 1 when connected. Electrical power, control signals etc. may be transferred in a separate cable, or umbilical, or may be combined in an umbilical together with one or more of the risers as mentioned. To allow continuous operation of the DPS during periods where no vessel 1 is connected as described above, a not shown cable or set of cables are arranged at the seabed from a power and control site onshore, or an offshore installation located in an area less exposed to the rough conditions mentioned above, as ice, icebergs etc. or at shallower water depths, to be able to produce oil in the absence of a vessel 1 connected to the risers.

The combined production and transport vessel 1 is a tank vessel equipped with disconnectable moorings and flowlines, such as a turret loading and production connection system for connection to the buoy. The vessel may also be equipped with an offloading arrangement so it can offload oil directly to shuttle tankers, thus avoiding disconnection only to empty the vessels storage tanks.

A separator system 40 is arranged onboard the vessel to receive produced oil from the DPS via riser 6, separate oil, gas and any water present in the produced oil. The separator system 40 operates at a pressure suitable for efficient separation of oil and higher fractions of gas, as the efficiency of oil and gas separation is highly dependent on the pressure. Separation at a pressure close to ambient pressure at the surface, i.e. at about atmospheric pressure, is far more efficient than separation at higher pressures, and is a prerequisite for transport of the oil in tanks that are not pressurized.

The oil and gas process on the production and transport vessel is a typical oil and gas separation process that can be simplified since most of the methane will be separated on the seabed. No details of the onboard separator is illustrated as number of separation stages must be selected to suit the fluid composition in question for each specific reservoir. Additionally, separator as such is not a part of the invention, and the engineering of such a separator is within the skill of the skilled person given the composition and relative volumes of the fluid to be separated.

Water separated in the separator 40 is returned via a water return line 47, pumped by means of a return water pump 34 and led through the riser 7. The water returned to the DPS is preferably injected directly into the water injection well to avoid mixing of the returned produced water with seawater. Alternatively, the returned water may be introduced into a water pipeline 17 or a network of water pipelines 17, connecting to the water cushion in the tanks 11, 12 to give a common water reservoir in the tanks, or to the top of the water purification tank. Mixing of the returned water with seawater is preferably avoided as it may cause scaling in piping and tanks depending on the reservoir properties. Accordingly, the injection of produced water is preferably balanced towards the separation of produced water separated in the separation tank 12, and any produced water returned from the vessel 1 through riser 7. In situations where more water for injection is needed, water taken from the surrounding sea, optionally from the water in the storage tanks 3 or 4, may be used for injection, preferably into water injection wells separate from the water injection well(s) 37 for re-injection of produced water to avoid scaling.

Oil separated in the separator 40 is introduced into tanks 41 onboard the vessel 1 via a separated oil line 48. Gas separated in the separator 40, is compressed, and is returned into the seabed via a gas return line and is injected directly into the reservoir or exported as sales gas if such grid is made available.

Power for operation of control systems, pumps, compressors, valves etc. is provided from a remote position as mentioned above, via one or more not illustrated cables. The DPS is also remotely controlled and monitored from a remote position through the cable. The skilled person will also understand that power supply, monitoring and/or control of the DPS may be temporally taken over from the vessel when the vessel 1 is connected to the risers. When disconnected, the risers will normally be connected to a buoy, or the like, such as a submerged production buoy. The buoy may then be floating below the surface at a depth sufficient to avoid direct contact with ice or icebergs at the surface, when the vessel is disconnected, either due to the tank capacity of the vessel being filled, or due to weather or ice conditions.

A set of valves 5″, 6″, 7″, 8″, 32″, 53″ at the top of the risers are closed when the buoy is not connected to a vessel at the surface to avoid spillage. Valves 5′, 6′, 7′, 8′, 32′, 53′ are preferably closed when the vessel is disconnected as a safety measure in case of damage to the risers or valves 5″, 6″, 7″, 8″, 32″, 53″.

As soon as production from the oil production well is started, oil is filled into the separation and storage tanks 12 replacing water. Water is constantly injected through the water injection well 23. As mentioned above, the injection water is taken out of the tanks. All, or a substantial part of the water replaced by the oil is injected into the formation through the water injection well(s). If more water is withdrawn from the tanks 12, 13 than the water separated in separation tank 12, additional water will naturally flow in though the sea water line 28. Ingress of sea water into the produced water may, as mentioned above, result in scaling due to formation of heavy soluble salts, and is preferably avoided as described above. As mentioned above, the oil concentration in the produced water in the separation tank 12 or the water purification tank 13, that may be released from the DPS is far lower than the current regulations allows. Additionally, as all or most of the displacement water is used for injection, the volume of water discharged from the DPS during operation is low or close to non-existing.

After a certain period of “offline” production, or production without any connected vessel 1, oil storage capacity of the DPS is filled with oil. Preferably, the DPS comprises produced oil storage tank(s) to increase the produced oil storage capacity and thus the duration of offline production. After filling the oil storage capacity of the DPS when in offline mode, the production has to be stopped if weather and ice conditions or the availability of a vessel 1 does not allow connection of a vessel 1.

As soon as the vessel 1 is connected to the risers and the internal connections are made onboard the vessel 1, the relevant valves 5′, 6′, 7′, 8′, 32′, 53′, 5″, 6″, 7″, 8″, 32, 53″ may be opened, and separation as described above, may start. The oil is then withdrawn from the separation and storage tanks 12, or from a produced oil storage tank 4, driven by the density difference between the product and seawater, separated in the separator 40 onboard the vessel, and gas and water are returned to the DPS for injection or further treatment. If gas production and separation has been large, gas must be produced from the cell first to submerge the oil offtake line in oil for it to function. The separated water being returned through the water riser 7 is preferably led directly to the water injection well 37 for injection. By injecting the separated water in riser 7 directly, the separated water may have a relatively high oil content and should then not be included in the common water purification tank, which again ascertains a low oil content in any water discharged from the sea water line 28.

Production and separation is then continued until the oil tanks 41 onboard the vessel are full, or until the ice and/or weather conditions forces the vessel to disconnect from the risers.

If weather and ice conditions allows, conditions the DPS is allowed to produce oil continuously, which means that the oil tanks 41 onboard the combined production and transport vessel 1 are filled with oil at the same time as the DPS separation and storage tanks 12, or the produced oil storage tank(s) 4, are substantially empty. Production may then be continued by filling the oil tanks with oil from the oil production well, and withdrawing gas for gas injection as described above, until the next combined production and transport vessel 1 arrives and is ready to start separation. To allow such maximum production and transport, the number and size of the combined production and transport vessels 1 serving the oil field has to be adjusted according to the production rate of the oil well, and the distance to the harbor to receive the oil.

The skilled person will understand that features not specifically mentioned with regard to the embodiment of FIG. 2 or 3 corresponds to corresponding features of the embodiment of FIG. 1, and that only differences between the embodiments are described to avoid repeating what is already described above.

A great advantage with the present invention is that production from the oil production well(s) may continue as long as there is capacity in the oil separation tank(s) 12 and/or the produced oil storage tank(s) 4, for more oil. Accordingly, oil may be produced continuously even if the ice and/or weather conditions do not allow the combined production and transport vessel 1 to be continuously connected to the DPS via the buoy. Provided that the capacity of the pipelines and separation equipment onboard the vessel is sufficient, a continuous production may be maintained even if the conditions only allows the combined production and transport vessel 1 to be connected for relatively short periods. Subsea stabilized oil tank(s) 3 on the DPS makes it possible to produce more stabilized oil in periods allowing longer connection time between the vessel 1 and the DPS than needed for filling the onboard stabilized oil tank 41. The stabilized oil in tank 3 may be loaded onto alternative vessels 1 lacking the processing capacity of the separator 4, or loaded onto a vessel if the expected time window for connection is too short for full processing of the produced oil.

The present solutions does thus allow for continuous or substantially continuous oil production even in waters with extremely hard weather and ice conditions where the conditions may shift extremely fast.

Another advantage of the system invention is that avoiding product transfer to a shuttle tanker reduces the risk of oil spillage into the sea, which is a major challenge in remote areas. The system will be most productive if the environmental conditions are such that disconnections are not too frequent, and a separate oil transport vessel is used for oil transport. The DPS is then used to maintain regular production independent on the disturbance on the surface.

An alternative to gas injection is gas export in subsea pipeline to another gas export facility. This may be a realistic alternative towards tail end production when most of the oil is produced and pressure support is no longer needed.

The connection between the vessel and the pipelines, i.e. the combination of the turret arranged in the vessel, and the buoy, is designed to be easy and rapidly connectable and dis-connectable without resulting in spillage of oil.

Other solutions than the turret and buoy type of solutions, allowing easy and rapid connection and disconnection of the risers and at the same time allows for rotation of the vessel without twisting anchor lines, pipelines and/or umbilical(s) will also be useful.

The oil produced in some reservoirs is contaminated by salt and has to be desalted for sale on the common market. The DPS lends itself to enable desalting by spraying seawater over the oil in the storage tanks. The water will sink through the oil and wash out some of the salts.

Oil and water separation is often enhanced by an electrostatic coalescor. Such an equipment solution may be introduced into the system to increase the droplets size and thus enhance separation if required.

1. A method for oil production in remote deepwater areas, the method comprising the steps of:
producing hydrocarbons from one of more subsea well(s) and introducing the produced hydrocarbons into one or more separation tank(s) in a subsea oil production unit (DPS) resting at the sea bed,
allowing the produced hydrocarbons to separate from associated gas and water in one or more tank(s), to give a gas phase, an oil phase and a produced water phase,
conducting at least a part of the produced water separated from the oil in the DPS to subsea injection well(s) through an injection pump,
providing a temporary fluid connection between the separation tank(s) and a production and transport vessel for transporting separated oil from the separation tank(s) to the vessel and gas and water from the vessel,
conducting separated oil from the storage and separation tank(s) to the vessel,
separating the stream of hydrocarbons into stabilized oil, gas and water in a separation system onboard the vessel,
introducing the separated oil into storage tank(s) onboard the vessel,
returning separated gas and water to the DPS,
injecting the returned water and/or gas into water and/or gas injection wells, respectively,
disconnecting the vessel from the fluid contact if disconnection is required,
continuing hydrocarbon production from the subsea well(s) when the DPS and the vessel are disconnected until the separation tank(s), and/or produced oil storage tank(s), are filled with produced oil.

2. The method of claim 1, wherein gas separated from the oil inside the separation and storage tanks(s) is withdrawn from the tank(s) and injected into the gas injection well(s).

3. The method of claim 1 or 2, wherein at least a part of the gas returned from the vessel to the DPS is temporarily stored in the separation and storage tank at the top of the oil, or in a separate gas tank in the DPS before being injected into the gas injection well(s).

4. The method of any of the preceding claims, wherein the volume per time unit of produced water withdrawn from the separation tank for injection is controlled to be equal to or smaller than the volume of produced water separated therein per time unit.

5. The method of any of the preceding claims, wherein gas and/or water injection is continued even when the vessel is disconnected.

6. The method of any of the preceding claims, wherein the produced water from the pool additionally comprises gravitation purification of displacement water prior to discharge into the sea or prior water injection of surplus displacement water into the sea.

7. The method of any of the preceding claims, wherein at least a part of the water separated from the produced oil onboard the vessel and returned to the DPS and is treated by gravitational cleaning in a water purification tank before discharge to sea.

8. The method of any of the preceding claims, where at least a part of the water returned to the DPS after being separated from the oil in the separator system onboard the vessel, is injected directly into the reservoir.

9. The method of any of the preceding claims, wherein the vessel is a production vessel and the method further comprises transferring the oil from the storage tank(s) to tank vessels for export of the oil.

10. The method of any of the claims 1-8, wherein the vessel is a combined production and transport vessel and where the vessel is disconnected for exporting the oil when the storage tank is filled.

11. A system for oil production in remote deepwater areas, the system comprising a deep sea production unit (DPS) (10), comprising one or more separation tanks (12) for separation of oil, gas, and produced water arranged on the sea bed (9), where one or more hydrocarbon production well(s) (36) is(are) connected to the DPS (10) via raw oil line(s) (26),
one or more injection well(s) (35, 37) for gas and/or water connected via water and/or gas pipelines (25, 27, 27′),
a power, monitoring and control cable connected to the DPS from a remote location,
flexible risers (5, 6, 7, 8, 32, 53) for gas, oil and water, respectively, connected to the DPS (10), designed to be removably connectable to combined production and transport vessel(s) (1),
wherein the system additional comprises a production vessels (1) equipped with a separator system (40) for separation of the produced oil into separated oil to be filled in tanks onboard the vessel, gas, and water, and where a water riser (7) and/or a gas riser (5), are provided for returning the water and gas, respectively, to the sea bed for injection for pressure support for enhanced oil recovery.

12. The system according to claim 11, wherein the water riser (7) is connected to a water injection line (27′) on the DPS to allow for injection of the return water.

13. The system according to claim 11 or 12, additionally comprising anchor lines connected to anchors in one end, and removably connectable to the production vessel (1).

14. A system according to any of the claims 10 to 12, wherein the flow risers are removably connectable to the vessel (1) by means of a submerged turret production buoy (2) that can be connected to the vessels being provided with a turret (3).

15. The system according to any of the claims 11 to 14, wherein the production vessel (1) is a combined production and transport vessel.

16. The system according to any of the claims 11 to 14, wherein the system further comprises an offloading arrangement for offloading of oil to tank vessels for export of the oil.
